(19) United States
(12) Patent Application Publication
(10) Pub. No.: US 2012/0297151 A1
(43) Pub. Date: Nov. 22, 2012

(54) MEMORY MANAGEMENT APPARATUS, MEMORY MANAGEMENT METHOD AND CONTROL PROGRAM

(76) Inventors: Hiroki KAMINAGA, Kanagawa (JP); Seiya Ichimori, Kanagawa (JP); Katsuya Takahashi, Kanagawa (JP); Yoriko Komatsuzaki, Tokyo (JP); Masahiro Tamori, Kanagawa (JP)

(21) Appl. No.: 13/465,448

(22) Filed: May 7, 2012

(30) Foreign Application Priority Data
May 16, 2011 (JP) 2011-109045

(51) Int. Cl. G06F 12/00

(52) U.S. Cl. 711/154; 711/E12.001

(57) ABSTRACT

If it is determined in step S51 that allocation for an instruction part has been requested and it is determined in step S52 that a memory use amount of an instruction part of an allocation target program exceeds an upper limit, a memory area that is being used by the instruction part of the allocation target program is released in step S53 and memory allocation for the instruction part is performed in step S54. If it is determined in step S52 that the memory use amount of the instruction part of the allocation target program does not exceed the upper limit, the process in step S53 is skipped. If it is determined in step S51 that allocation for a data part is requested, a normal memory allocation process is performed in step S55. The present disclosure may be applied to, for example, an embedded device.

### BACKGROUND

The present disclosure relates to a memory management apparatus, a memory management method, and a control program, and more particularly, to a memory management apparatus, a memory management method, and a control program that suppress an execution frequency of a memory release process.

In related art, as a technique of limiting a use amount of a memory (a main storage device) in units of programs, for example, cgroup of Linux is known (e.g., see Balbir Singh, et al., “Containers: Challenges with the memory resource controller and its performance,” Proceedings of the Linux Symposium Volume Two, Canada, Jun. 27-30, 2007, p. 209-222).

If cgroup is used, programs (processes) executed in a system may be divided into a plurality of groups and an upper limit of a memory use amount may be set for each group.

FIG. 1 is a graph showing an example of a transition of a memory use amount of a group consisting of one program in a system in which a memory use amount for each group is limited using cgroup. A horizontal axis indicates time and a vertical axis indicates the memory use amount. In FIG. 1, L1 denotes an upper limit of the memory use amount of this group.

In this example, an example of a case in which an auxiliary storage device is non-writable and data on the memory cannot be evacuated to the auxiliary storage device is shown.

As an operating time of a system becomes long, the memory use amount of the group increases as shown in FIG. 1. If the memory use amount reaches the upper limit L1 at a time t1, a memory release process to secure a necessary memory area is executed, for example, by releasing a memory area in which an instruction part of the program in the group can be discarded, even when there is a vacant area in the memory of the overall system. Further, when a plurality of programs are included in the group, for example, a less important program may be forcibly terminated for the memory release process. Then, each time the memory use amount reaches the upper limit L1, the execution of the memory release process is repeated.

FIG. 2 is a graph showing the transition of the memory use amount of FIG. 1 of an instruction part of the program and a data part separate from the instruction part.

Each time the memory release process is executed, the memory use amount of the data part is hardly changed and the memory use amount of the instruction part is reduced, as shown in FIG. 2. This is because the data part is not discarded but should be held in the memory if a value of the data can be rewritten, and accordingly, a memory area for the instruction part allowed to be discarded is released.

Further, in a system using cgroup, even when a memory use amount of the overall system reaches a predetermined upper limit, the memory release process is executed in order to secure a necessary memory area.

### SUMMARY

When a memory release process is executed, an overall system is consumed for the process. Accordingly, for example, system response is degraded or operation becomes unstable (e.g., disturbance of video or audio). In particular, when capacity of a memory mounted on, for example, an embedded device is small, an execution frequency of the memory release process becomes high and capability of the system is greatly degraded.

The present disclosure enables an execution frequency of a memory release process to be suppressed while also suppressing degradation of capability of a system.

According to an embodiment of the present disclosure, there is provided a memory management apparatus including: a memory management unit for controlling an arrangement of a program from an auxiliary storage device to a main storage device and limiting a capacity to arrange an instruction part of the program in the main storage device.

The memory management unit may limit the capacity for the instruction part to be arranged in the main storage device for each program.

A setting unit for dynamically setting an upper limit of the capacity for the instruction part to be arranged in the main storage device based on a predetermined condition for each program may be provided

An algorithm for arranging the instruction part in the main storage device may be set for each program in the memory management unit.

The memory management unit may predict an instruction part to be executed in the future and arrange the instruction part in the main storage device before the instruction part is necessary.

According to another embodiment of the present disclosure, there is provided a memory management method including: controlling, by a memory management apparatus, an arrangement of a program from an auxiliary storage device to a main storage device and limiting a capacity to arrange an instruction part of the program in the main storage device.

According to another embodiment of the present disclosure, there is provided a program for causing a computer to execute a process, the process including: controlling an arrangement of a program from an auxiliary storage device to a main storage device and limiting a capacity to arrange an instruction part of the program in the main storage device.

According to another embodiment of the present disclosure, an arrangement of a program from an auxiliary storage device to a main storage device is controlled and a capacity to arrange an instruction part of the program in the main storage device is limited.

According to the aspect of the present disclosure, it is possible to suppress the execution frequency of the memory release process while suppressing degradation of the capability of the system.

### BRIEF DESCRIPTION OF THE DRAWINGS

FIG. 1 is a graph showing an example of a transition of a memory use amount of a system using cgroup;

FIG. 2 is a graph showing the transition of the memory use amount of FIG. 1 of an instruction part of a program and a data part separate from the instruction part;

FIG. 3 is a block diagram showing an embodiment of an information processing system to which the present disclosure has been applied;

FIG. 4 is a flowchart illustrating a maximum instruction memory allocation amount setting process;

FIG. 5 is a flowchart illustrating a memory allocation process;

FIG. 6 is a diagram illustrating a concrete example of a memory allocation process;

FIG. 7 is a diagram illustrating a concrete example of a memory allocation process;

FIG. 8 is a graph showing an example of a transition of a memory use amount of a system to which the present disclosure has been applied;

FIG. 9 is a graph showing the transition of the memory use amount of FIG. 8 of an instruction part of a program and a data part separate from the instruction part; and

FIG. 10 is a graph showing a comparison between transitions of the memory use amount of a system using cgroup and a system using the present disclosure.

### DETAILED DESCRIPTION OF THE EMBODIMENT(S)

Hereinafter, a mode for carrying out the present disclosure (hereinafter referred to as an embodiment) will be described. Further, a description will be given in the following order.

1. Embodiment

2. Variants

### 1. Embodiment

### Configuration Example of Information Processing System

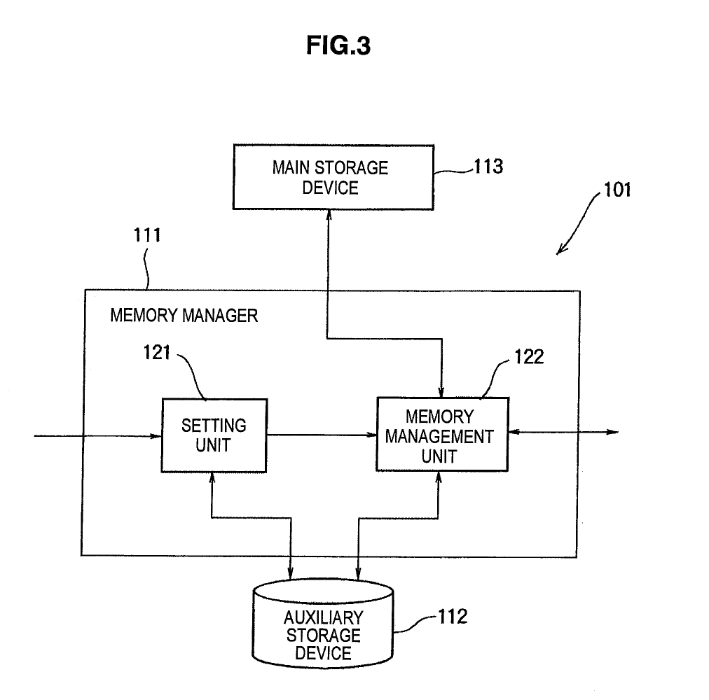

FIG. 3 is a block diagram showing an embodiment of an information processing system 101 to which the present disclosure has been applied.

The information processing system 101, for example, is a system that can be applied to television receivers, various embedded devices such as mobile telephones, computers, or the like.

Hereinafter, an apparatus, a system or the like to which the information processing system 101 has been applied will be simply referred to as a system.

The information processing system 101 includes a memory manager 111, an auxiliary storage device 112, and a main storage device 113.

The memory manager 111 performs memory management for the information processing system 101. For example, the memory manager 111 controls an arrangement of programs or data from the auxiliary storage device 112 to the main storage device 113.

Further, the memory manager 111 may be realized by either software or hardware or may be realized by a combination thereof. When the memory manager 111 is realized by the software, for example, the memory manager 111 is realized as a part of a function of an OS (operating system) executed by a processor, such as a CPU (Central Processing Unit), which is not shown. On the other hand, when the memory manager 111 is realized by the hardware, the memory manager 111, for example, is realized by a memory management unit (MMU).

The auxiliary storage device 112, for example, includes a storage device, such as a ROM (Read Only Memory), a hard disk drive, or a flash memory, which has a larger capacity than the main storage device 113 and generally has a low access speed.

Further, the auxiliary storage device 112 may be a data writable storage device or may be a data non-writable storage device.

The main storage device 113 includes, for example, a data writable storage device, such as a RAM (Random Access Memory).

Hereinafter, the main storage device 113 is simply referred to as a memory. Hereinafter, an area of the main storage device 113 is referred to as a memory area and a use amount is also referred to as a memory use amount.

A configuration example of a function of the memory manager 111 will be described herein. The memory manager 111 includes a setting unit 121 and a memory management unit 122.

The setting unit 121 sets an upper limit of a capacity of the main storage device 113 in which an instruction part of each program stored in the auxiliary storage device 112 is allowed to be arranged (hereinafter referred to as a maximum instruction memory allocation amount) based on, for example, information input from the outside, for each program. The setting unit 121 reports the set maximum instruction memory allocation amount to the memory management unit 122 or stores the set maximum instruction memory allocation amount in the main storage device 113.

The memory management unit 122 controls an arrangement of programs or data from the auxiliary storage device 112 to the main storage device 113 according to a request from a program executed by a processor such as a CPU, which is not shown, a use situation of the main storage device 113, or the like. For example, the memory management unit 122 arranges programs or data stored in the auxiliary storage device 112, in the main storage device 113 or discards the programs or the data stored in the main storage device 113, as necessary. Further, if the auxiliary storage device 112 is writable, the memory management unit 122 evacuates the programs or data stored in the main storage device 113 to the auxiliary storage device 112 as necessary.

Further, the memory management unit 122 limits an instruction part of each program stored in the auxiliary storage device 112 so that capacity arranged in the main storage device 113 is the same as or less than the maximum instruction memory allocation amount.

### [Maximum Instruction Memory Allocation Amount Setting Process]

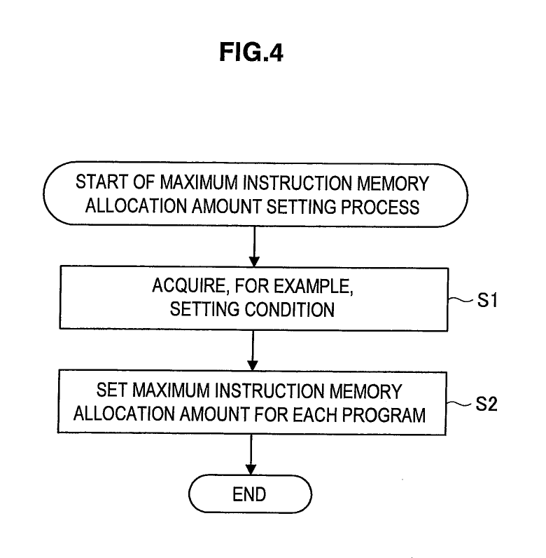

Next, a maximum instruction memory allocation amount setting process executed by the information processing system 101 will be described with reference to a flowchart of FIG. 4.

This process is initiated, for example, at a predetermined timing, such as start-up of the information processing system 101, or when a setting value of the maximum instruction memory allocation amount is input to the memory manager 111.

In step S1, the setting unit 121 acquires, for example, a setting condition.

In step S2, the setting unit 121 sets the maximum instruction memory allocation amount for each program based on, for example, the acquired setting condition. The setting unit 121 reports or stores the set maximum instruction memory allocation amount to the memory management unit 122 or in the main storage device 113.

Then, the maximum instruction memory allocation amount setting process ends.

A concrete example of a method of setting the maximum instruction memory allocation amount will be described herein.

For example, the setting unit 121 reads an initial value of the maximum instruction memory allocation amount of each program from the auxiliary storage device 112 when the information processing system 101 starts up. The setting unit 121 sets the maximum instruction memory allocation amount of each program to the initial value.

The initial value of the maximum instruction memory allocation amount of each program is set based on, for example, a priority or a scale of each program. For example, for a program that should be preferentially executed, the initial value is set to a great value, and for a program allowed to be executed with delay, the initial value is set to a small value. Further, for example, for a program having a large scale, the initial value is set to a great value, and for a program having a small scale, the initial value is set to a small value.

Further, for example, the setting unit 121 changes the maximum instruction memory allocation amount of a program that is being executed in response to a request from the program. For example, each program requests to increase the maximum instruction memory allocation amount when an execution frequency is expected to be high and to decrease the maximum instruction memory allocation amount when the execution frequency is expected to be low.

Further, for example, the setting unit 121 changes the maximum instruction memory allocation amount for each program based on, for example, a state or an operation environment of the information processing system 101. For example, when a predetermined function is executed, the setting unit 121 increases a maximum instruction memory allocation amount for a program necessary to realize the function and decreases a maximum instruction memory allocation amount for an unnecessary program. Alternatively, for example, in a predetermined time, the setting unit 121 increases a maximum instruction memory allocation amount for a program necessary to realize a function assumed to be executed in the vicinity of that time and decreases a maximum instruction memory allocation amount for an unnecessary program.

The condition for changing the maximum instruction memory allocation amount described above is one example and the maximum instruction memory allocation amount may be changed based on other conditions.

The maximum instruction memory allocation amount may be fixed instead of being dynamically set.

### [Memory Allocation Process]

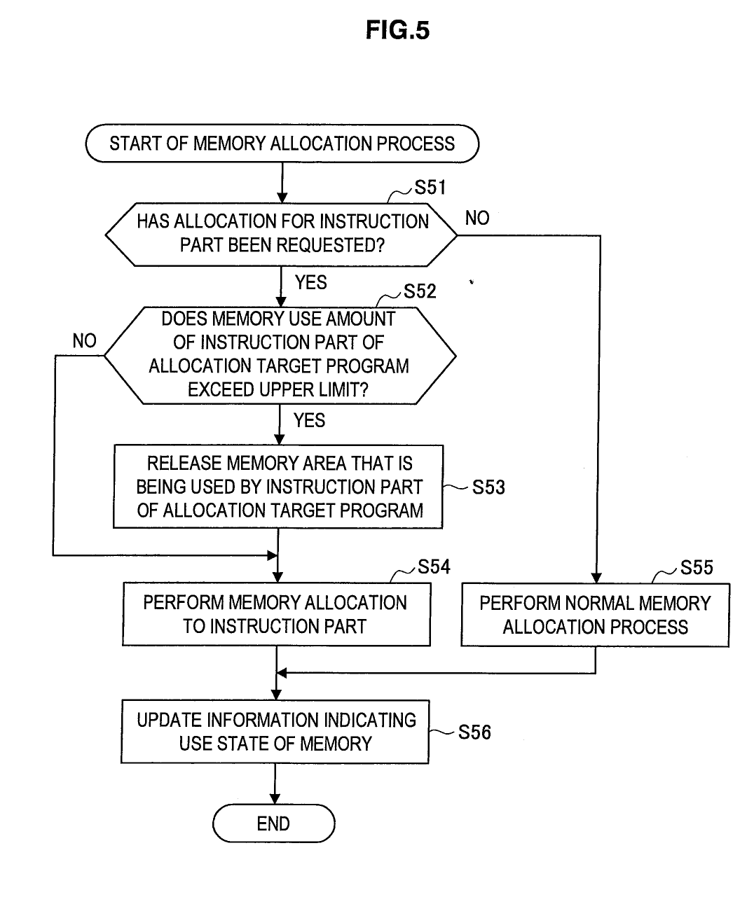

Next, a memory allocation process executed by the information processing system 101 will be described with reference to a flowchart of FIG. 5. This process is initiated, for example, when memory allocation is requested to the memory management unit 122. This memory allocation request, for example, may be explicitly made by a program that is being executed or may be made, for example, by an OS without a program.

Hereinafter, a program that is a target on which the memory allocation is performed is referred to as an allocation target program.

In step S51, the memory management unit 122 determines whether the allocation for an instruction part has been requested. If it is determined that the allocation for the instruction part has been requested, the process proceeds to step S52.

In step S52, the memory management unit 122 determines whether a memory use amount of the instruction part of the allocation target program exceeds an upper limit. Specifically, the memory management unit 122 obtains a sum of a capacity for the instruction part for which the allocation has been requested and a current memory use amount of the instruction part of the allocation target program (a capacity of the main storage device 113 in which the instruction part of the allocation target program has been arranged). If the obtained sum exceeds the maximum instruction memory allocation amount for the allocation target program, the memory management unit 122 determines that the memory use amount of the instruction part of the allocation target program exceeds the upper limit and the process proceeds to step S53.

In step S53, the memory management unit 122 releases a memory area that is being used by the instruction part of the allocation target program. Specifically, the memory management unit 122 releases at least a portion of the memory area that is being used by the instruction part of the allocation target program so that an available amount of a memory allocation amount for the allocation target program is the same as or more than the capacity for the instruction part for which the allocation has been requested. Here, the available amount of the memory allocation amount is a value obtained by subtracting the memory use amount from the maximum instruction memory allocation amount of the allocation target program.

As an algorithm for determining the memory area to be released at this time, for example, any algorithm such as LRU (Least Recently Used) or a ring buffer can be adopted.

The process then proceeds to step S54.

On the other hand, if it is determined in step S52 that the memory use amount of the instruction part of the allocation target program does not exceed the upper limit, the process of step S53 is skipped and the process proceeds to step S54.

In step S54, the memory management unit 122 performs the memory allocation for the instruction part. That is, the memory management unit 122 reads the instruction part of the allocation target program for which the allocation has been requested from the auxiliary storage device 112, and arranges the instruction part in a vacant area of the main storage device 113.

The process then proceeds to step S56.

On the other hand, if it is determined in step S51 that allocation for a data part has been requested, the process proceeds to step S55.

In step S55, the memory management unit 122 performs a normal memory allocation process. For example, if a capacity for the data part of the allocation target program for which the allocation has been requested is equal to or less than the vacant capacity of the main storage device 113, the memory management unit 122 reads the data part from the auxiliary storage device 112 and arranges the data part in the vacant area of the main storage device 113.

On the other hand, if the capacity for the data part for which the allocation has been requested exceeds the vacant capacity of the main storage device 113, the memory management unit 122 performs release of the used area of the main storage device 113 so that the vacant capacity of the main storage device 113 is the same as or more than the capacity for the data part.

In this case, as an algorithm for releasing the memory area, any algorithm such as LRU (Least Recently Used) or FIFO (First In First Out) can be adopted.

The memory management unit 122 reads the data part for which the allocation has been requested from the auxiliary storage device 112 and arranges the data part in the vacant area of the main storage device 113.

The process then proceeds to step S56.

In step S56, the memory management unit 122 updates information indicating a use state of the memory. For example, the memory management unit 122 updates information indicating the used area and the vacant area of the main storage device 113 or updates information indicating a memory use amount of the instruction part of each program.

Then, the memory allocation process ends.

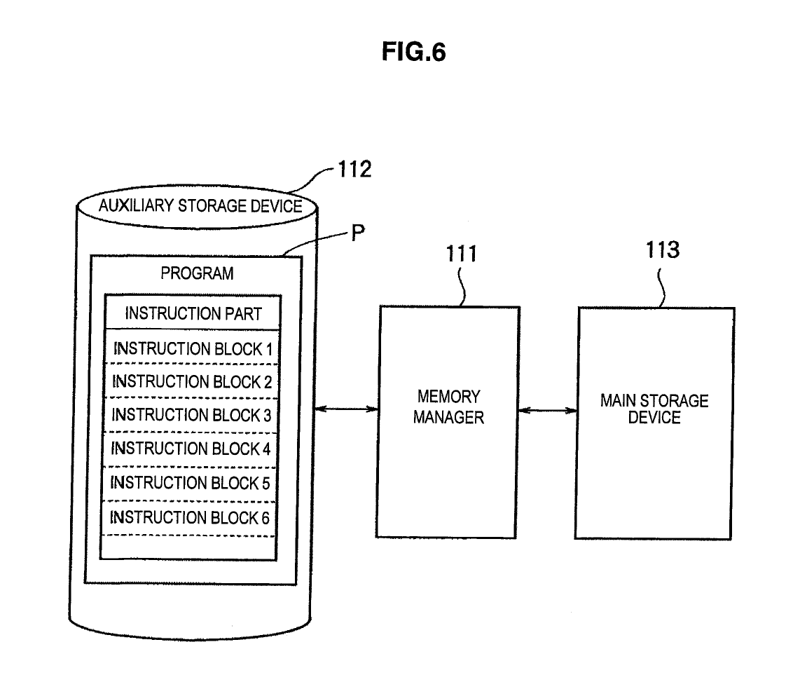

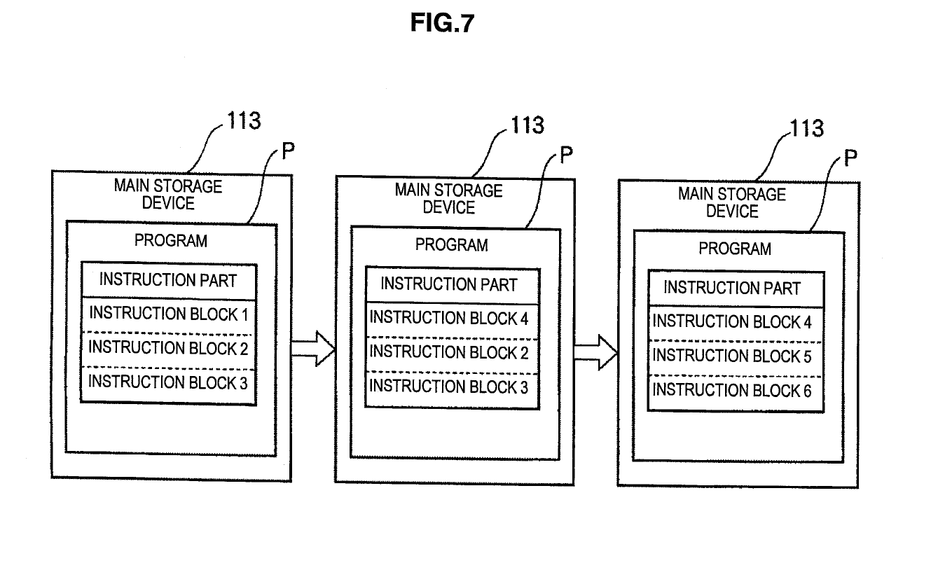

As the concrete example of the memory allocation process of FIG. 5, a case in which the memory allocation is performed on an instruction part of a program P stored in the auxiliary storage device 112 will be described herein with reference to FIGS. 6 and 7.

The instruction part of the program P is assumed to be divided into six blocks, i.e., instruction blocks 1 to 6. The instruction blocks correspond to, for example, pages in a virtual storage system, and are assumed to have the same size and include a plurality of instructions of the program P.

Hereinafter, instruction blocks 1 to 6 are assumed to be sequentially executed in ascending order from instruction block 1. Further, a maximum instruction memory allocation amount of the program P is assumed to be set to 3 blocks.

For example, since the maximum instruction memory allocation amount is not exceeded until instruction blocks 1 to 3 are arranged in the main storage device 113, instruction block 1, instruction block 2 and instruction block 3 are arranged in order in the main storage device 113, as shown in the left of FIG. 7.

When instruction block 4 is directly arranged in the main storage device 113, the memory use amount of the instruction part of the program P exceeds the maximum instruction memory allocation amount. For example, an area for instruction block 1 first arranged in the main storage device 113 is released, and the released area is allocated to instruction block 4. As a result, instruction blocks 2 to 4 are arranged in the main storage device 113, as shown in a center of FIG. 7.

Similarly, an area for instruction block 2 is released and then allocated to instruction block 5, and an area for instruction block 3 is released and then allocated to instruction block 6. Finally, instruction blocks 4 to 6 are arranged in the main storage device 113, as shown in the right of FIG. 7.

As described above, the memory use amount of the instruction part for each program is limited, and the memory use amount of the data part separate from the instruction part is limited in the overall system, as in related art. As a result, it is possible to suppress a memory use amount of the overall system and to suppress the execution frequency of the memory release process.

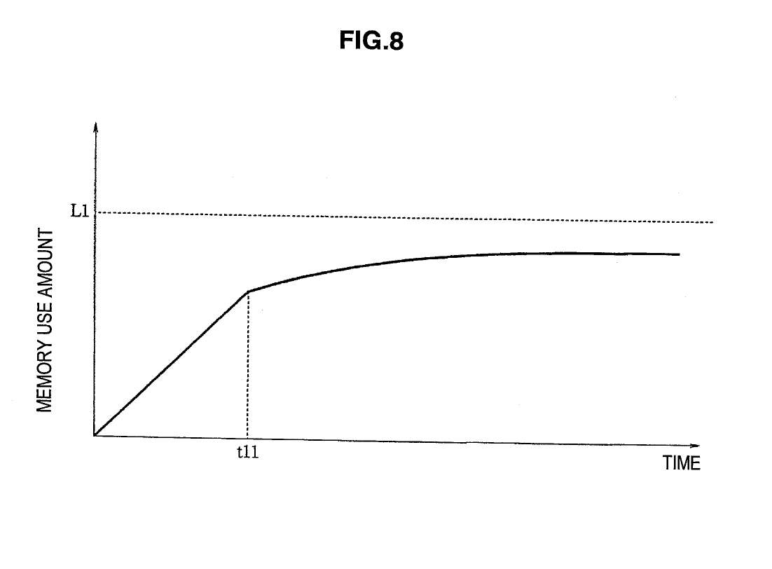

This will be described with reference to FIGS. 8 to 10.

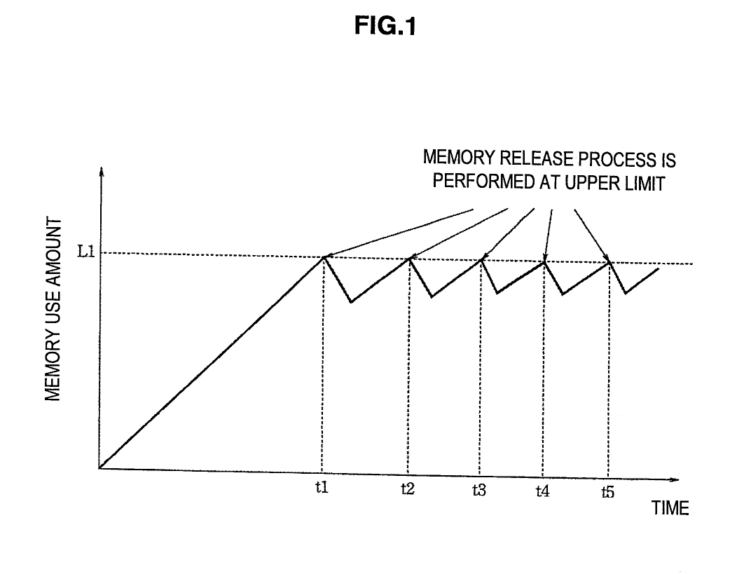

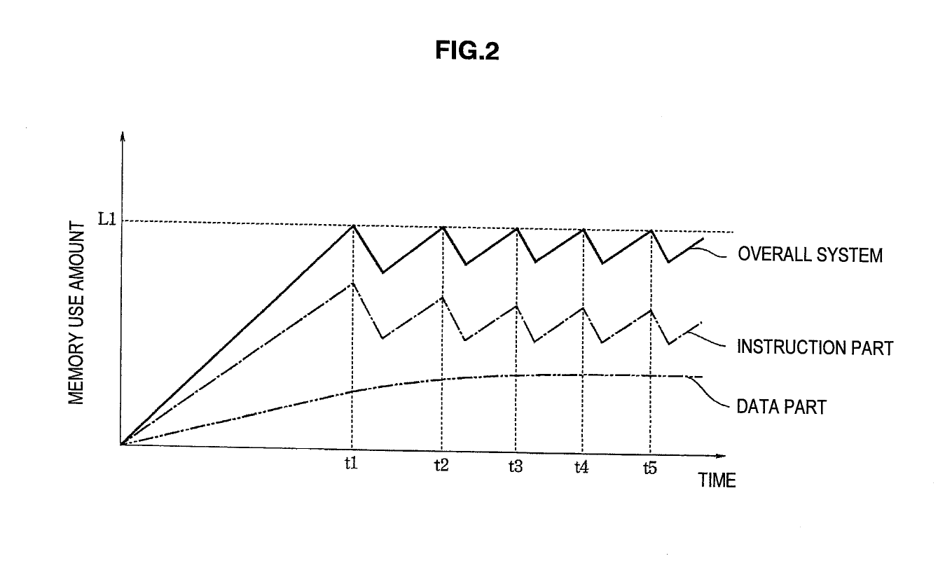

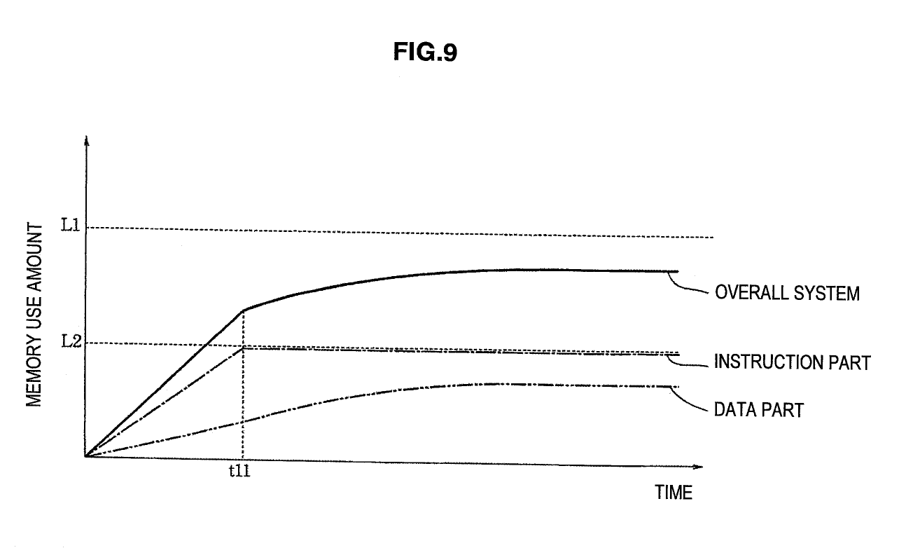

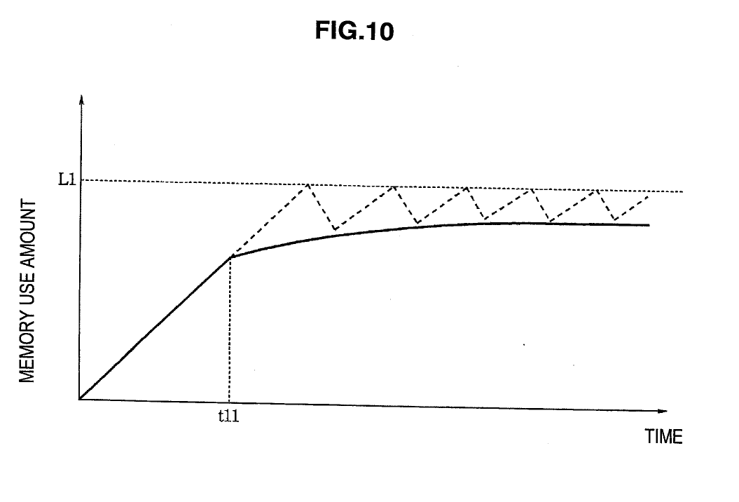

FIG. 8 shows an example of a transition of the memory use amount when a program included in the group exhibiting the transition of the memory use amount in FIG. 1 described above (hereinafter referred to as comparison target program) is executed by a system to which the information processing system 101 has been applied. FIG. 9 is the same graph as FIG. 2 described above and shows the transition of the memory use amount in FIG. 8 of an instruction part and a data part separate from the instruction part. FIG. 10 shows a comparison between the graph of FIG. 1 and the graph of FIG. 8, and is a graph showing a comparison between transitions of the memory use amount of the comparison target program in the system using cgroup and the system using the information processing system 101.

L1 in FIGS. 8 to 10 has the same value as L1 in FIGS. 1 and 2. In FIG. 9, L2 denotes an upper limit of the memory use amount of the instruction part of the comparison target program. Further, a graph indicated by a solid line in FIG. 10 shows the transition of the memory use amount of the comparison target program in the system using the information processing system 101, and a graph indicated by a dotted line shows the transition of the memory use amount of the group consisting of the comparison target program in the system using cgroup.

In this example, the auxiliary storage device 112 is non-writable and it is difficult for the data on the main storage device 113 to be evacuated to the auxiliary storage device 112.

As an operating time of a system becomes long, the memory use amount of the comparison target program increases, as shown in FIGS. 8 to 10. However, when the memory use amount of the instruction part reaches the upper limit L2 at a time t11, the memory use amount of the instruction part no longer increases. Accordingly, an increase in the memory use amount of the comparison target program is suppressed as compared with the system using cgroup.

Thus, in the system using the information processing system 101, as the increase in the memory use amount for each program is suppressed, a memory use amount of the overall system can be suppressed and an execution frequency of the memory release process can be suppressed. Accordingly, degradation of the capability of the system due to the execution of the memory release process can be suppressed.

As a result, it is possible to prevent, for example, the system from being temporarily with high load, a response of the system from being degraded, and operation from being unstable (e.g., disturbance of video or audio).

Further, for example, when a start-up order of programs has been determined at the time of start-up of the system, a maximum instruction memory allocation amount of a program that should be first started up but has low priority is set to a small value. Accordingly, it is possible to prevent the program from occupying the memory, the memory release process from being executed, and the start-up from being delayed at the time of start-up of the system.

It is also possible to arrange more data other than the instruction part in the main storage device 113 and to accelerate or stabilize a system operation.

In the system using cgroup, when the memory use amount of the group exceeds the limit value, an error process is executed, for example, programs in the group are forcibly terminated even when there is a vacant area of the memory of the overall system, as described above.

On the other hand, in the information processing system 101, even when the memory use amount of the instruction part of the program exceeds the limit value, the data part of the program can be arranged in the main storage device 113 and the error process as described above is not executed if there is a vacant area in the main storage device 113. As a result, it is possible to stabilize the operation of the system.

Further, in the information processing system 101, the maximum instruction memory allocation amount can be set to an appropriate value for each program, an execution frequency of rearrangement of the instruction part can be suppressed, and degradation of the capability of the system can be suppressed. Further, as the maximum instruction memory allocation amount is dynamically changed as described above, the execution frequency of the rearrangement of the instruction part can be suppressed and degradation of the capability of the system can be suppressed.

### 2. Variants

Hereinafter, variants of the embodiment of the present disclosure will be described.

### [Variant 1]

In the above description, the example in which the maximum instruction memory allocation amount is set for each program has been shown. However, for example, respective programs may be classified into a plurality of groups and the maximum instruction memory allocation amount may be set for each group. That is, for each group, the memory use amount of the instruction parts of all programs belonging to the group may be limited not to exceed the maximum instruction memory allocation amount.

Alternatively, for example, one maximum instruction memory allocation amount may be set in the overall system. That is, the memory use amount of the instruction part of all programs executed in the system may be limited not to exceed the maximum instruction memory allocation amount.

### [Variant 2]

Further, an algorithm for arranging the instruction part in the main storage device 113 (an algorithm for memory allocation to the instruction part) may be set for each program or for each above group.

For example, a different algorithm may be used for each program or for each group to adjust a frequency of rearrangement of the instruction part.

Alternatively, for example, a different algorithm may be used for each program or for each group to change a criterion for releasing the memory area for the instruction part (e.g., a use frequency of the memory area or a period of time in which the memory area has been secured).

Further, when an overall program is configured of run binaries and shared libraries, different algorithms may be used for instruction parts of the run binaries and an instruction part of the shared libraries to increase reusability of the instruction parts of the shared libraries.

### [Variant 3]

For example, advance reading of the instruction part may be performed in order to further increase an execution speed. That is, an instruction part executed to be in the future may be predicted, read from the auxiliary storage device 112 before the instruction part is necessary, and arranged in the main storage device 113.

Further, the prediction of the instruction part to be executed in the future may be considered to be performed, for example, based on a profile indicating an execution order of an instruction part of each program when the system operates, which is acquired in advance.

### [Variant 4]

In the example of FIGS. 6 and 7, the example in which the instruction part of the program is arranged in the main storage device 113 in units of blocks having a constant size has been shown. The present disclosure may also be applied to a case in which the size of the block of the instruction part arranged in the main storage device 113 is not constant. The present disclosure may also be applied to, for example, a case in which the instruction part is arranged in the main storage device 113 in units of instructions or segments rather than the blocks.

### [Variant 5]

A set of processes described above may be executed by hardware or may be executed by software.

When the set of processes is executed by the software, a program constituting the software is installed in a computer. Here, examples of the computer include a computer embedded in dedicated hardware, a general-purpose personal computer capable of executing various functions through various installed programs, and the like.

The program executed by the computer, for example, may be recorded and provided in a removable medium as a package medium. Alternatively, the program may be provided via a wired or wireless transmission medium, such as a local area network, the interne, or digital satellite broadcasting. Alternatively, the program may be installed in a storage device (e.g., the auxiliary storage device 112) embedded in the apparatus, in advance.

Further, a program executed by the computer may be a program in which processes are performed in time series in the order described in the present specification or may be a program in which processes are performed in parallel or at a necessary timing, such as when a call is made.

In the present specification, the terminology “system” refers to an overall apparatus including a plurality of apparatuses, units or the like.

Further, the embodiment of the present disclosure is not limited to the above-described embodiment and various changes may be made to the present disclosure without departing from the scope and spirit of the present disclosure.

Additionally, the present technology may also be configured as below.

(1)

A memory management apparatus comprising:

a memory management unit for controlling an arrangement of a program from an auxiliary storage device to a main storage device and limiting a capacity to arrange an instruction part of the program in the main storage device.

(2)

The memory management apparatus according to (1), wherein the memory management unit limits capacity for the instruction part to be arranged in the main storage device for each program.

(3)

The memory management apparatus according to (2), further comprising a setting unit for dynamically setting an upper limit of the capacity for the instruction part to be arranged in the main storage device based on a predetermined condition for each program.

(4)

The memory management apparatus according to any one of (1) to (3), wherein the memory management unit sets an algorithm for arranging the instruction part in the main storage device for each program.

(5)

The memory management apparatus according to any one of (1) to (4), wherein the memory management unit predicts an instruction part to be executed in the future and arranges the instruction part in the main storage device before the instruction part is necessary.

(6)

A memory management method comprising controlling, by a memory management apparatus, an arrangement of a program from an auxiliary storage device to a main storage device and limiting a capacity to arrange an instruction part of the program in the main storage device.

(7)

A program for causing a computer to execute a process, the process comprising: controlling an arrangement of a program from an auxiliary storage device to a main storage device and limiting a capacity to arrange an instruction part of the program in the main storage device.

The present disclosure contains subject matter related to that disclosed in Japanese Priority Patent Application JP 2011-109045 filed in the Japan Patent Office on May 16, 2011, the entire content of which is hereby incorporated by reference.

What is claimed is:

1. A memory management apparatus comprising:
a memory management unit for controlling an arrangement of a program from an auxiliary storage device to a main storage device and limiting a capacity to arrange an instruction part of the program in the main storage device.

2. The memory management apparatus according to claim 1, wherein:
the memory management unit limits the capacity for the instruction part to be arranged in the main storage device for each program.

3. The memory management apparatus according to claim 2, further comprising:
a setting unit for dynamically setting an upper limit of the capacity for the instruction part to be arranged in the main storage device based on a predetermined condition for each program.

4. The memory management apparatus according to claim 1, wherein:
the memory management unit sets an algorithm for arranging the instruction part in the main storage device for each program.

5. The memory management apparatus according to claim 1, wherein:
the memory management unit predicts an instruction part to be executed in the future and arranges the instruction part in the main storage device before the instruction part is necessary.

6. A memory management method comprising:
controlling, by a memory management apparatus, an arrangement of a program from an auxiliary storage device to a main storage device and limiting a capacity to arrange an instruction part of the program in the main storage device.

7. A program for causing a computer to execute a process, the process comprising:
controlling an arrangement of a program from an auxiliary storage device to a main storage device and limiting a capacity to arrange an instruction part of the program in the main storage device.
